(19) United States
(12) Patent Application Publication
(10) Pub. No.: US 2017/0279663 A1
(43) Pub. Date: Sep. 28, 2017

(54) SWITCHING METHOD, TRANSMISSION DEVICE, AND RECORDING MEDIUM

(71) Applicant: FUJITSU LIMITED, Kawasaki-shi (JP)

(72) Inventor: Masaru TANAKA, Kahoku (JP)

(73) Assignee: FUJITSU LIMITED, Kawasaki-shi (JP)

(21) Appl. No.: 15/453,183

(22) Filed: Mar. 8, 2017

(30) Foreign Application Priority Data
Mar. 23, 2016 (JP) 2016-059176

(51) Int. Cl. H04L 12/24; H04L 12/703; H04L 12/707

(52) U.S. Cl. CPC H04L 41/0654; H04L 41/12; H04L 45/22; H04L 45/28

(57) ABSTRACT

A switching method includes receiving a failure notification through each of two or more paths included in a plurality of paths; by referring to path management information in which a group and a combination of a plurality of predetermined paths are associated with each other for each of a plurality of groups generated by grouping the plurality of paths according to a combination of an initial point and an end point, determining, for each of the plurality of groups, whether a combination of paths through which the failure notification is received matches with the combination of the plurality of predetermined paths; and switching a path included in an object group corresponding to the two or more paths from an active system to a standby system, when it is determined that the combination of the two or more paths matches with the combination of the plurality of predetermined paths.

### CROSS-REFERENCE TO RELATED APPLICATION

This application is based upon and claims the benefit of priority of the prior Japanese Patent Application No. 2016-059176, filed on Mar. 23, 2016, the entire contents of which are incorporated herein by reference.

### FIELD

The embodiment discussed herein is related to a switching method, a transmission device, and a recording medium.

### BACKGROUND

As transmission bands increase and networks become larger in scale, the number of paths arranged among transmission devices in the networks increases as well. When a transmission device detects a failure of a communication line, for example, the transmission device transmits an alarm indication signal (AIS) for each path so as to notify the failure to transmission devices arranged downstream in the direction of transmission.

When the transmission device located most downstream on the path receives an AIS, for example, an interrupt occurs in an internal central processing unit (CPU) and based on the interrupt process, the most downstream transmission device switches the path from an active system to a standby system. Accordingly, communication continues through a detour path around a location where the failure has occurred. Examples disclosed as related art include Japanese Laid-open Patent Publication No. 10-210050 and Japanese Laid-open Patent Publication No. 2003-229888.

To reduce influence on communication of a network, a transmission device is desired to complete path switching of all paths within certain time, which is 50 msec for example. In a transmission device, however, an interrupt process of a CPU occurs in every path switching. Thus, as the number of paths as switched objects increases, time allowable for each path switching decreases.

When for example, 1000 AISs are transmitted at the time of failure occurrence, the most downstream transmission device is desired to execute path switching for 1000 times within for example, 50 msec. Thus, each path switching is desired to be completed within 50 μsec. In contrast, when for example, a transmission device is provided with a high-performance CPU, path switching within desired certain time is possible. However, another problem occurs, which is increase in cost. In view of the above, it is desirable to shorten, time taken for path switching of a transmission device.

### SUMMARY

According to an aspect of the invention, a switching method executed by a processor included in a transmission device that communicates with another transmission device using a plurality of paths, the switching method includes receiving a failure notification from the another transmission device through each of two or more paths included in the plurality of paths; by referring to path management information in which a group and a combination of a plurality of predetermined paths are associated with each other for each of a plurality of groups generated by grouping the plurality of paths according to a combination of an initial point and an end point, determining, for each of the plurality of groups, whether a combination of paths through which the failure notification is received matches with the combination of the plurality of predetermined paths; and switching a path included in an object group corresponding to the two or more paths among the plurality of groups from an active system to a standby system, when it is determined that the combination of the two or more paths matches with the combination of the plurality of predetermined paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram that illustrates an example of a path of a network;

FIG. 2 illustrates a comparative example of path switching operation;

FIG. 3 illustrates path switching operation according o an embodiment;

FIG. 4 is a configuration diagram that illustrates an example of a network management device;

FIG. 5 illustrates an example of a path management table;

FIG. 6 is a configuration diagram that illustrates an example o a transmission system;

FIG. 7 is a configuration diagram that illustrates an example of a control unit;

FIG. 8 is a flow chart that illustrates n example of a transmission process of an alarm indication signal (AIS); and

FIG. 9 is a flow chart that illustrates an example of a path witching process.

### DESCRIPTION OF EMBODIMENT

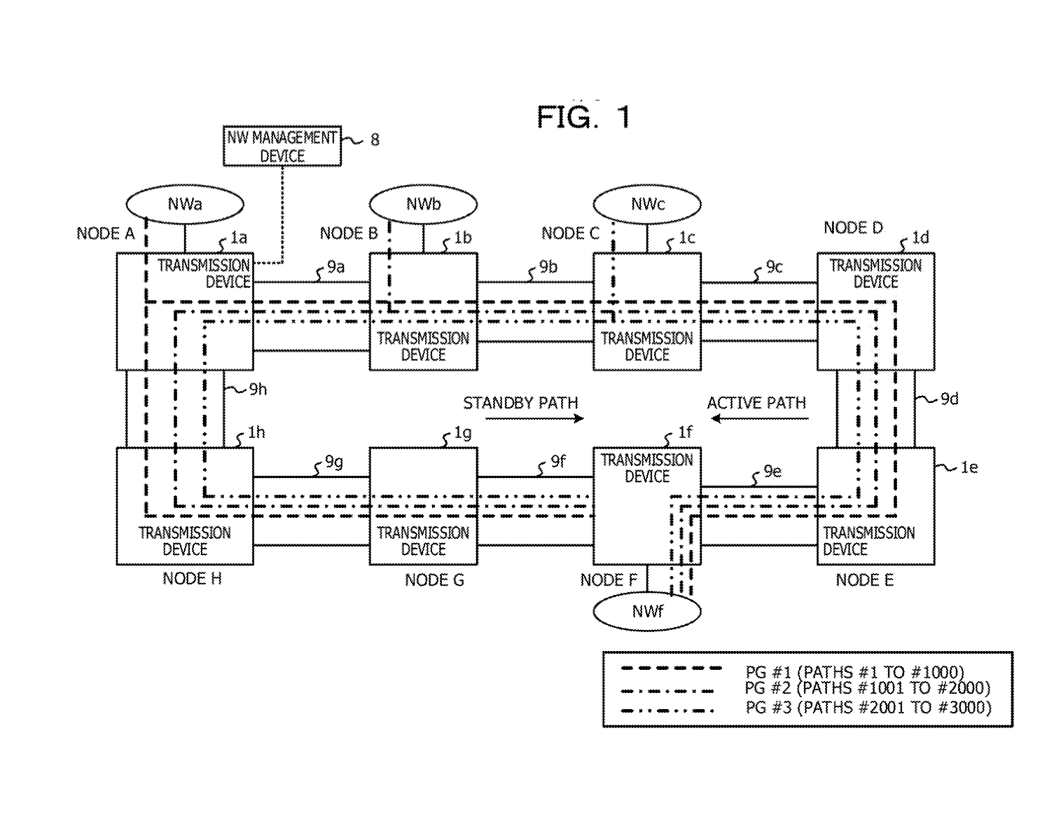

FIG. 1 is a configuration diagram that illustrates an example of a path of a network. In FIG. 1, a network in which nodes A to H are coupled like a ring is taken as an example. A path switching method, which is described below, however, is not limited to a ring network and may be used for a mesh network.

Transmission devices 1a to 1h are arranged at the nodes A to H, respectively. For example, the transmission devices 1a to 1h transmit a synchronous optical network (SONET)/synchronous digital hierarchy (SDH) frame, which is hereinafter referred to as a “main signal”. The transmission devices 1a to 1h are mutually coupled through physical communication lines 9a to 9h, such as optical fibers.

The transmission devices 1a to 1c are coupled to other networks NWa to NWc, respectively. Examples of the networks NWa to NWc include a subscriber system network that implements Fiber to the Home (FTTH) and a relay system metro ring network. The networks NWa to NWc are not limited to these examples, however. The network according to the present example functions as a backbone network of the networks NWa to NWc.

Each of the transmission devices 1a to 1h is coupled to a network (NW) management device 8 through a network for supervisory control, which is not illustrated. In FIG. 1, only the transmission device 1a included in the transmission devices 1a to 1h is coupled to the NW management device 8. In actuality, however, the other transmission devices 1b to 1h are also coupled to the NW management device 8.

The NW management device 8 performs supervisory control over each of the transmission devices 1a to 1h. For example, the NW management device 8 sets paths for transmitting a main signal with respect to the transmission devices 1a to 1h. The communication lines 9a to 9h among the transmission devices 1a to 1h accommodate a plurality of paths. For example, the paths are present for logical channels arranged in a main signal, respectively.

The paths are divided into path groups (PG) #1 to #3 to be managed, which correspond to combinations of the source nodes A to H and the destination nodes A to H of the main signal. The paths in each of the path groups #1 to #3 have a redundant configuration with two paths, which are an active path and a standby path, so as to be ready for a failure in the communication lines 9a to 9h.

As indicated by dashed lines, paths #1 to #1000 of the path group #1 are arranged between the transmission device 1a of the node A and the transmission device 1f of the node F. The communication between the network NWa and a network NWf is performed through the paths #1 to #1000 of the path group #1.

The active path of the path group #1 passes through the transmission devices 1a to 1f of the nodes A to F in this order. The standby path of the path group #1 passes through the transmission devices 1a, 1h, 1g, and 1f of the nodes A, H, G, and F in this order. That is, in the front view of FIG. 1, the active path is a clockwise path where the nodes A and F serve as the initial point and the end point, respectively. In the front view of FIG. 1, the standby path is a counter-clockwise path where the nodes A and F serve as the initial point and the end point, respectively.

As indicated by dash-dot lines, paths #1001 to #2000 of the path group #2 are arranged between the transmission device 1b of the node B and the transmission device 1f of the node F. The communication between the network NWb and the network NWf is performed through the paths #1001 to #2000 of the path group #2.

The active path of the path group #2 passes through the transmission devices 1b to 1f of the nodes B to F in this order. The standby path of the path group #2 passes through the transmission devices 1b, 1a, 1h, 1g, and 1f of the nodes B, A, H, G, and F in this order. That is, in the front view of FIG. 1, the active path is a clockwise path where the nodes B and F serve as the initial point and the end point, respectively. In the front view of FIG. 1, the standby path is a counter-clockwise path where the nodes B and F serve as the initial point and the end point, respectively.

As indicated by dash-dot-dot lines, paths #2001 to #3000 of the path group #3 are arranged between the transmission device 1c of the node C and the transmission device 1f of the node F. The communication between the network NWc and the network NWf is performed through the paths #2001 to #3000 of the path group #3.

The active path of the path group #3 passes through the transmission devices 1c to 1f of the nodes C to F in, this order. The standby path of the path group #3 passes through the transmission devices 1c, 1b, 1a, 1h, 1g, and 1f of the nodes C, B, A, H, G, and F in this order. That is, in the front view of FIG. 1, the active path is a clockwise path where the nodes C and F serve as the initial point and the end point, respectively. In the front view of FIG. 1, the standby path is a counter-clockwise path where the nodes C and F serve as the initial point and the end point, respectively. Each of the path groups #1 to #3 is an example of a group based on a combination of an initial point and end point of a path.

When a failure occurs in the communication lines 9a to 9h, the transmission device that is included in the transmission devices 1a to 1h and has detected the failure transmits an AIS downstream. The AIS is an example of failure notification. When the transmission device that is included in the transmission devices 1a to 1h and is located most downstream in each path receives the AIS, the transmission device performs path switching to switch the path from the active system to the standby system. Examples of the configuration of the AIS include what is defined in International Telecommunication Union Telecommunication Standardization Sector (ITU-T) Recommendation G. 8013. The configuration is not limited to this example, however.

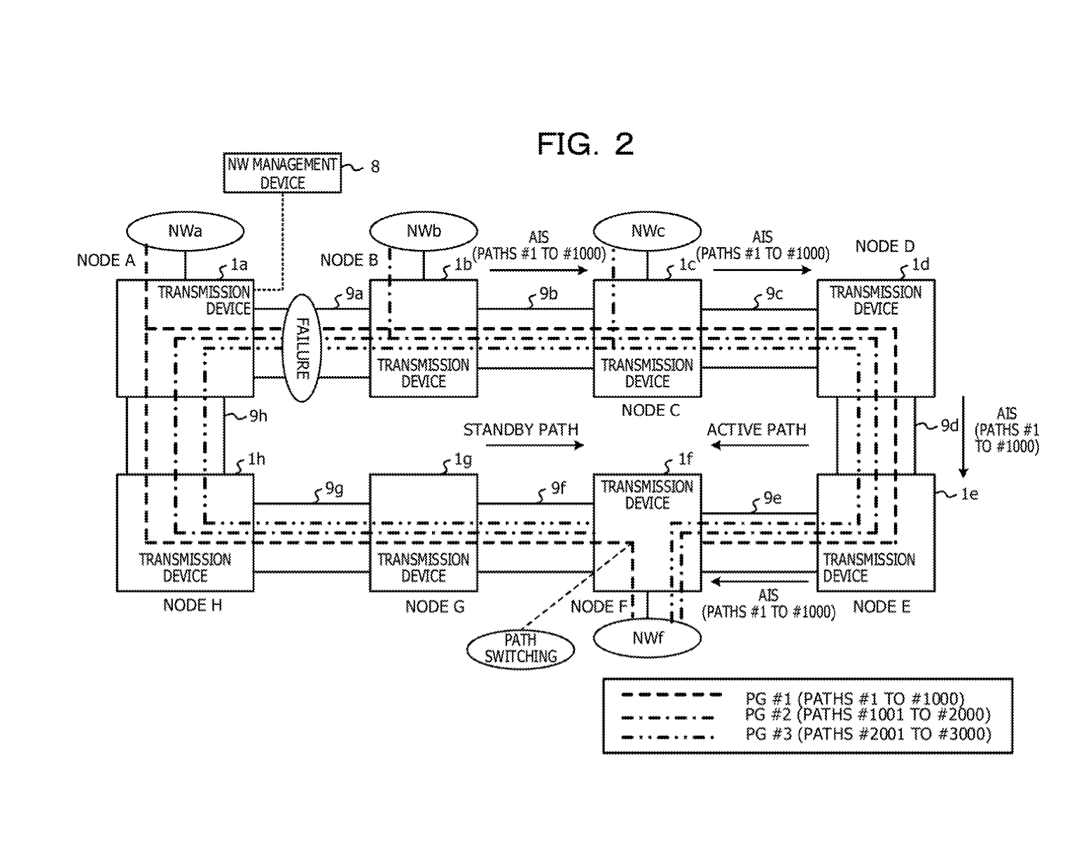

FIG. 2 illustrates a comparative example of the path switching operation. In FIG. 2, the same references are given to the constituents that are common to those in FIG. 1 and the descriptions thereof are omitted. The present example takes a case in which a failure occurs in the communication line 9a between the transmission device 1a of the node A and the transmission device 1b of the node B.

When the transmission device 1b detects the failure, the transmission device 1b generates an AIS for each of the paths #1 to #1000 in the path group #1 whose communication is disconnected by the failure. After that, the transmission device 1b transmits the generated AISs along the active path to the transmission device 1f of the node F located most downstream.

Since the AIS is issued for each path, 1000 AISs are transmitted in the present example.

On every reception of the AIS, the transmission device 1f of the node F causes an interrupt process in a CPU for device control. The'transmission device 1f performs path switching based on the interrupt process. Since the transmission device 1f receives the 1000 AISs, the transmission device 1f executes the interrupt process for 1000 times. Thus, the transmission device 1f performs path switching for all of the paths #1 to #1000 in the path group #1.

Accordingly, it is difficult to complete the entire path switching for the path group #1 within desired certain time, such as 50 msec. In contrast, for example, when the transmission device 1f is provided with a high-performance CPU, path switching within desired certain time may be possible. However, another problem occurs, which is increase in cost.

Thus, in an embodiment, when the paths in each of the path groups #1 to #3 are switched, the transmission device 1b transmits only AISs for the paths included in a combination of certain paths. After that, when the combination of the paths of the received AISs agrees with a combination of the certain paths, the transmission device 1f collectively switches all of the paths. Accordingly, path switching may be performed for many paths while the reception of AISs, the occurrences of the interrupt process, and the identification of the paths are omitted. As a result, time taken for the path switching may be shortened.

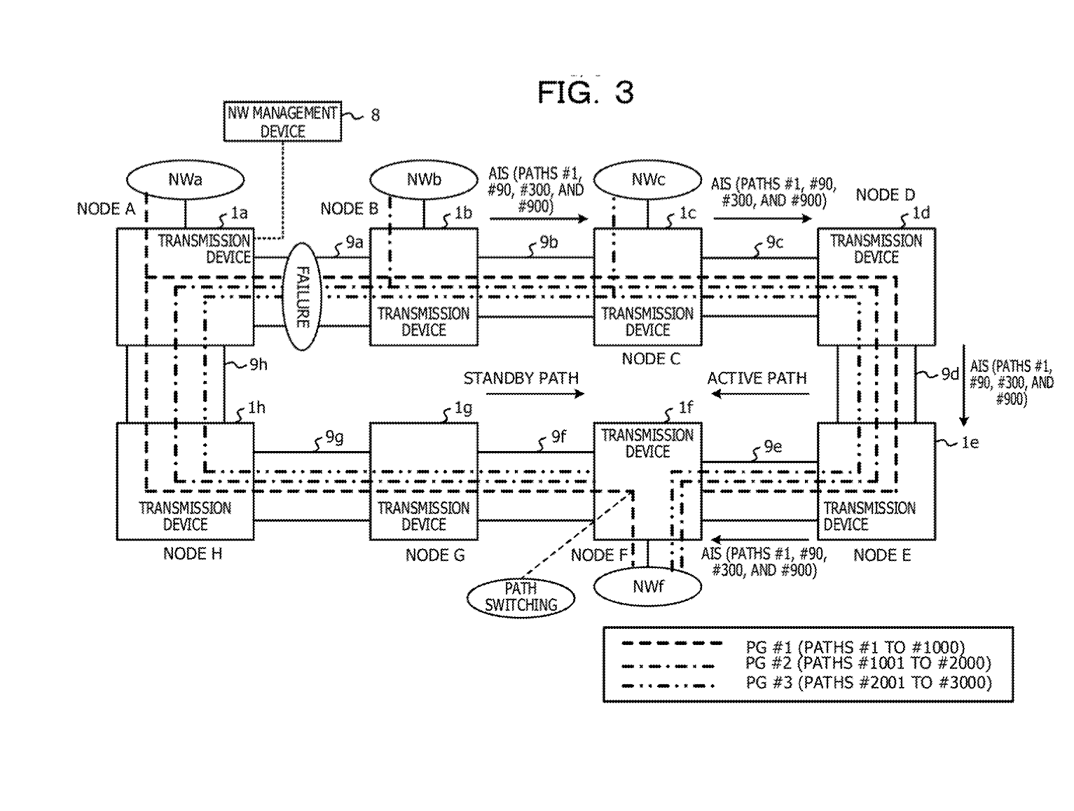

FIG. 3 illustrates path switching operation according to the embodiment. In FIG. 3, the same references are given to the constituents that are common to those in FIG. 1 and the descriptions thereof are omitted. Similar to the example of FIG. 2, the present example takes a case in which a failure occurs in the communication line 9a between the transmission device 1a of the node A and the transmission device 1b of the node B and each of the paths in the path group #1 affected by the failure is switched from the active system to the standby system.

When the transmission device 1b of the node B detects a failure, the transmission device 1b generates AISs only for certain paths, which are the paths #1, #90, #300, and #900 for example. After that, the transmission device 1b transmits the generated AISs to the transmission device 1f of the most downstream node F along the active path. Accordingly, four AISs are transmitted. The combination of the paths #1, #90, #300, and #900 through which the AISs are transmitted is determined in accordance with a path management table preset by the NW management device 8 for the transmission devices 1a to 1h.

On receiving the AISs, the transmission device 1f of the node F compares the combination of the paths through which the AISs are received with a combination of paths, which is registered in the path management table. When as a result of the comparison, the combination of the paths #1, #90, #300, and #900 through which the AISs are received agrees with a combination of paths registered in the path management table, the transmission device 1f collectively switches each of the paths in the path group #1 from the active system to the standby system.

In this manner, the transmission device 1b transmits AISs for only part of the path group #1, that is, the paths #1, #90, #300, and #900. After that, the transmission device 1f receives the AISs for the paths #1, #90, #300, and #900. Accordingly, all of the paths in the path group #1 are switched. Thus, since it is undesired for the transmission device 1f to perform a process for the AIS or an interrupt process individually for the paths in the path group #1, time taken for the path switching may be shortened. Although the present example takes a case in which the path switching is performed for the path group #1, the path switching may also be performed on the path groups #2 and #3, similarly.

To perform the path switching, each of the transmission devices 1a to 1h receives the path management table from the NW management device 8 in advance. The configuration of the NW management device 8 is described below.

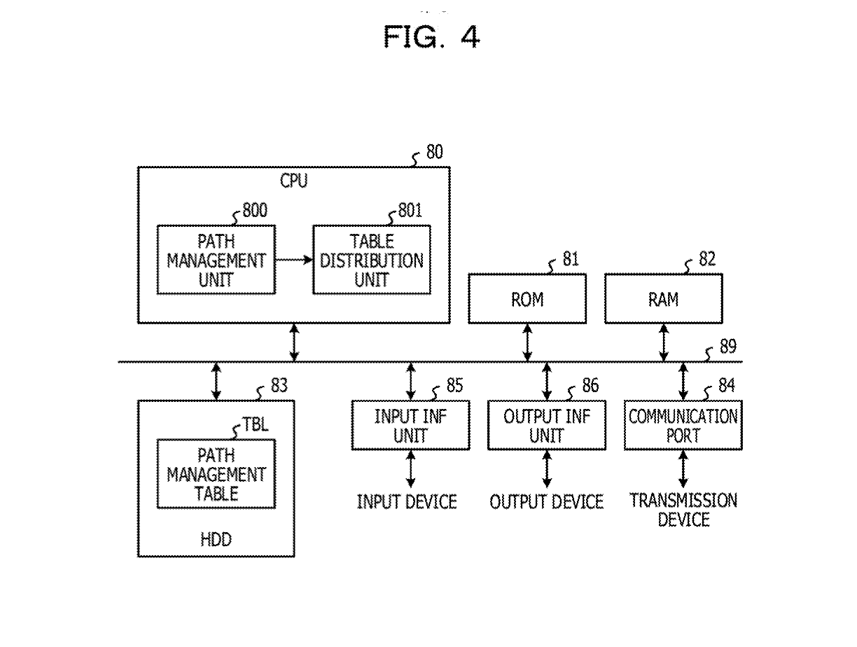

FIG. 4 is a configuration diagram that illustrates an example of the NW management device 8. For example, the NW management device 8 is a server for network management. The NW management device 8 is not limited to the server for network management, however.

The NW management device 8 includes a CPU 80, read only memory (ROM) 81, random access memory (RAM) 82, a hard disk drive (HDD) 83, a communication port 84, an input interface (INF) unit 85, and an output INF unit 86. The CPU 80 is coupled to the ROM 81, the RAM 82, the HDD 83, the communication port 84, the input INF unit 85, and the output INF unit 86 through a bus 89 so that signals may be mutually input and output.

The ROM 81 stores a program for driving the CPU 80. The RAM 82 functions as working memory of the CPU 80. The communication port 84 is for example, a network interface card (NIC), and packets are transmitted and received between the communication port 84 and each of the transmission devices 1a to 1h. The packet is for example, an Internet protocol (IP) packet. The packet is not limited to the IP packet, however.

The input INF unit 85 processes input and output of signals between the NW management device 8 and an input device that inputs information to the NW management device 8. Examples of the input device include a keyboard, a mouse, and a touch panel. The input INF unit 85 outputs the information input from the input device to the CPU 80 through the bus 89. The input INF unit 85 is made up of for example, a dedicated hardware device.

The output INF unit 86 processes input and output of signals between the NW management device 8 and an output device that outputs information on the NW management device 8. Examples of the output device include a display, a touch panel, and a printer. The output INF unit 86 acquires information from the CPU 80 through the bus 89 and outputs the information to the output device. The output INF unit 86 is made up of for example, a dedicated hardware device.

When the CPU 80 reads a program from the ROM 81, a path management unit 800 and a table distribution unit 801 are formed as functions. The path management unit 800 manages the paths set among the transmission devices 1a to 1h in accordance with the information input from the input INF unit 85 or the communication port 84. The path management unit 800 generates and updates a path management table TBL in which information on the paths is registered.

The HDD 83 stores the path management table TBL. As the storage for the path management table TBL, nonvolatile memory, such as erasable programmable ROM (EPROM), or the like may be used instead of the HDD 83.

When the path management unit 800 generates or updates the path management table TBL, the path management unit 800 notifies the table distribution unit 801 of the generation or updating. On receiving the notification, the table distribution unit 801 reads the path management table TBL from the HDD 83 and distributes the path management table TBL to each of the transmission devices 1a to 1h through the communication port 84. On receiving the path management table TBL, the transmission devices 1a to 1h causes the path management table TM to be stored in memory or the like.

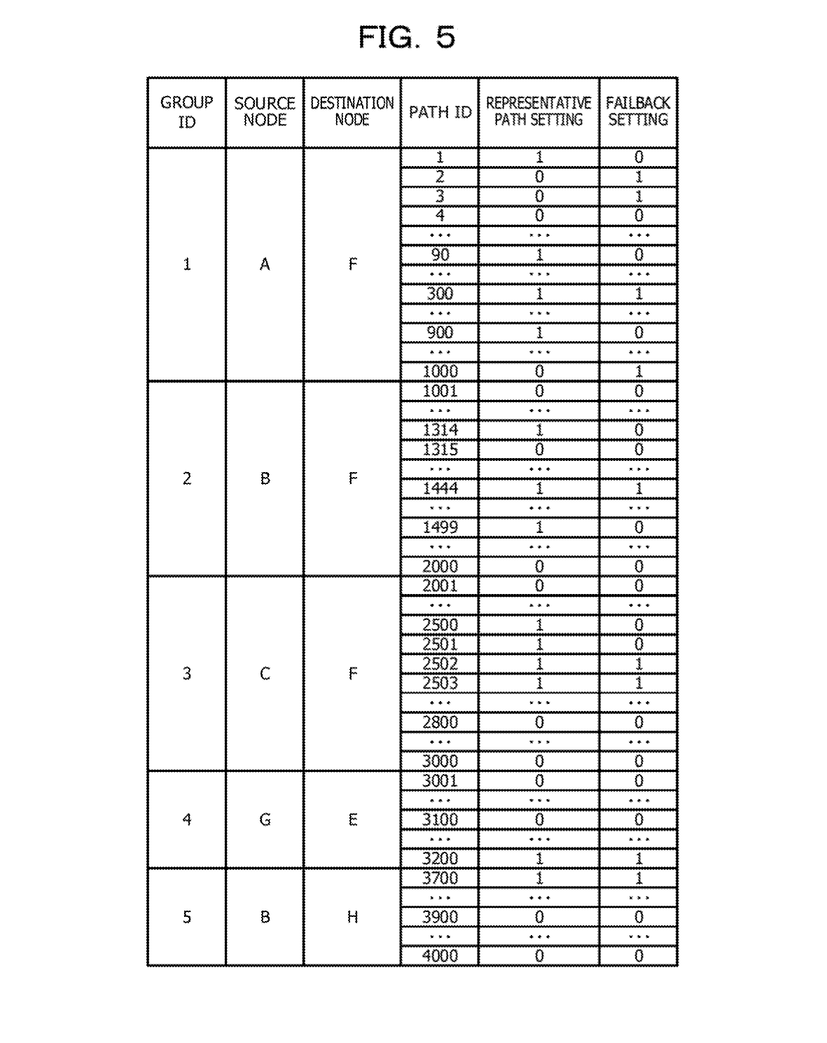

FIG. 5 illustrates an example of the path management table TBL. In the path management table TBL, group identifications (IDs) of the path groups, the source nodes A to H and destination nodes A to H of the path groups, path IDs of the paths that belong to the path groups, representative path setting information on each path, and failback setting information on each path are registered.

In the path management table TBL, which is an example of a table, a plurality of paths are registered in units of the above-described path groups. Accordingly, the path management unit 800 may manage the path groups as bunches of the paths based on each source node and each destination node.

In the present example, the paths #1 to #1000 of the source node A and the destination node F belong to the path group #1. The paths #1001 to #2000 of the source node B and the destination node P belong to the path group #2. The paths #2001 to #3000 of the source node C and the destination node F belong to the path group #3. Paths #3001 to #3200 of the source node G and the destination node E belong to a path group #4. Paths #3700 to #4000 of the source node B and the destination node H belong to a path group #5.

The representative path setting is, in a case where all of the paths in the path group concerned are switched, the setting about whether or not the paths are treated as transmission object paths of AISs while “0” indicates no transmission object and “1” indicates a transmission object. When the path group #1 is taken as an example, in the example of FIG. 3, the transmission device 1a transmits AISs for the paths #1, #90, #300, and #900 as the representative paths.

The transmission device 1f receives the AISs and searches for the path IDs #1, #90, #300, and #900 of the paths through which the AISs are received in the path management table TBL. Since the path IDs that have undergone the search agree with all of the representative paths in the path group #1, the transmission device 1f switches all of the paths in the path group #1.

That is, the representative path setting of each path group indicates the combinations of the paths of the AISs in switching all of the paths of the path group. The selection of the representative paths is not limited. The representative path setting is performed, however, so that at least two representative paths are included in each group.

The AISs for the paths other than the representative paths are transmitted after a lapse of certain time from the transmission of the AISs for the representative paths. On receiving the AISs, each of the transmission devices 1a to 1h notifies the NW management device 8 as a path failure. Accordingly, each of the transmission devices 1a to 1h transmits AISs for all of the paths ultimately so that the supervision of any path failure is not omitted.

The fallback setting is, when after switching all of the paths in a path group, an AIS for at least one path in the path group is not yet received, the setting about whether or not to restore the path corresponding to the yet-to-be-received AIS back from the standby system to the active system while “0” indicates no fallback performed and “1” indicates failback performed. Using FIG. 3 as an example, it is assumed that the transmission device 1f receives the AISs for the representative paths #1, #90, #300, and #900 in the path group #1, and after the lapse of certain time after all of the paths #1 to #1000 have been switched, determines that the AIS for the path #3 is not yet received.

In this case, the fallback setting for the transmission device 1f for the path ID “3” indicates “1”. The path #3 is therefore restored from the standby system back to the active system. Thus, even when the transmission device 1f receives the AISs for the representative paths regardless of it not being the case for switching all of the paths, the transmission device 1f may return the path that is no switched object, that is, the path through which no AIS is received, to the original active path. When it is undesired to restore the path, the fallback setting for the path may be caused to indicate “0”.

The configurations of the transmission devices 1a to 1h are described next. In the description below, the transmission device 1b of the node B and the transmission device 1f of the node F according to the example of FIG. 3 are exemplified as representatives. The other transmission devices 1a, 1c to 1e, 1g, and 1h also have similar configurations, however.

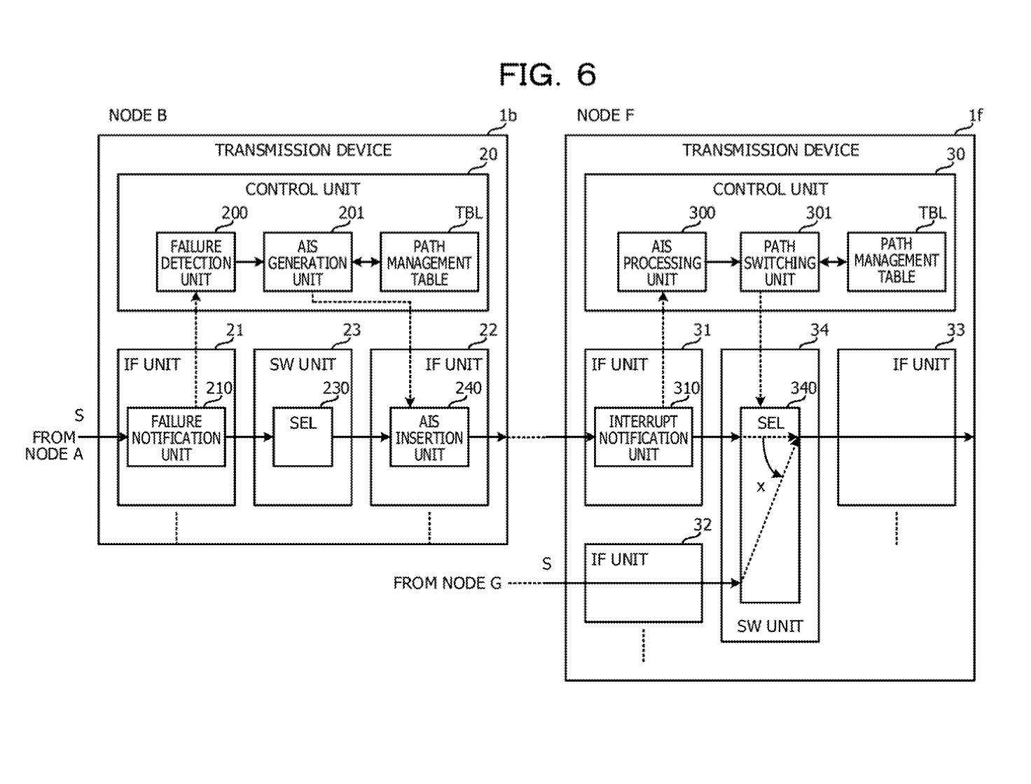

FIG. 6 is a configuration diagram that illustrates an example of a transmission system. The transmission system includes the transmission device lb of the node B, which is an example of a first transmission device, and the transmission device 1f of the node F, which is an example of a second transmission device. In FIG. 6, regarding the transmission device 1b, only the configuration related to the functions of detecting a failure and transmitting an AIS is illustrated for convenience of description. As for the transmission device 1f, only the configuration related to the functions of receiving an AIS and performing the path switching is illustrated. The transmission devices 1a and 1f have configurations similar to that of the transmission device 1b.

The transmission devices 1b and 1f include control units 20 and 30, a plurality of interface (IF) units 21, 22, and 31 to 33, and switch (SW) units 23 and 34. The control units 20 and 30, the IF units 21, 22, and 31 to 33, and the SW units 23 and 34 are for example, circuit boards over which electronic components are mounted, and are each inserted into slots provided on the respective front faces of the casings of the transmission devices 1b and 1f. The control units 20 and 30, the IF units 21, 22, and 31 to 33, and the SW units 23 and 34 are each coupled to wiring boards provided on the respective back faces of the transmission devices 1b and 1f and communicate with one another.

The IF units 21, 22, and 31 to 33 are coupled to the other ones of the transmission devices 1a to 1h and another network through a transmission path. The IF units 21, 22, and 31 to 33 transmit and receive a main signal and an AIS. The SW units 23 and 34 switch a main signal among the IF units 21, 22, and 31 to 33. The control units 20 and 30 control the IF units 21, 22, and 31 to 33, and the SW units 23 and 34. The flow of a main signal S is described first.

In the transmission device 1b of the node B, the IF unit 21 receives the main signal S from the transmission device 1a of the node A and transmits the main signal S to the SW unit 23. The SW unit 23 outputs the main signal S to the IF unit 22 through a selector unit (SEL) 230. The SEL 230 is provided in each path and switches the IF unit 21, which is the input source of the main signal S of the path, in accordance with the control of the control unit 20. The SW unit 23 outputs the main signal S to the IF unit 22 that corresponds to the destination of the main signal S.

The IF unit 22 is coupled to the transmission device 1c of the adjacent node C. The IF unit 22 transmits the main signal S to the transmission device 1c. Each of the transmission devices 1c to 1e of the nodes C to E transfers the main signal S to the transmission device 1f of the node F.

In the transmission device 1f of the node F, the IF unit 31 receives the main signal S from the transmission device 1e of the adjacent node E. The IF unit 31 outputs the main signal S to the SW unit 34. The IF unit 33 transmits the main signal S input from the SW unit 34 to the network NWf.

The SW unit 34 outputs the main signal S input from the IF unit 31 to the IF unit 33 that corresponds to the destination of the main signal S through a SEL 340 The SEL 340 is provided in each path and switches the input source of the main signal S of the path between the IF units 31 and 32 in accordance with the control of the control unit 30.

The IF unit 31 constitutes the active path while the IF unit 32 constitutes the standby path. The IF unit 32 is coupled to the transmission device 1g of the other adjacent node G. Although the SEL 340 normally receives the main signal S input from the IF unit 31, when the control unit 30 performs the path switching to the standby system, the main signal S is input from the IF unit 32.

A configuration related to the path switching is described now. In the transmission device 1b of the node B, the IF unit 21 includes a failure notification unit 210 and the IF unit 22 includes an AIS insertion unit 240. The control unit 20 includes a failure detection unit 200, an AIS generation unit 201, and the path management table TBL, which is an example of a first table. The failure detection unit 200 and the AIS generation unit 201 are formed as functions of the CPU of the control unit 20. The path management table TBL is stored in the memory of the control unit 20.

In the transmission device 1f of the node F, the IF unit 31 includes an interrupt notification unit 310. The control unit 30 includes an AIS processing unit 300, a path switching unit 301, and the path management table TBL, which is an example of a second table. The AIS processing unit 300 and the path switching unit 301 are formed as functions of the CPU of the control unit 30.

The path management table TBL is stored in memory of the control unit 30. Based on the example of FIG. 3, the operation performed in the path switching is described.

The failure notification unit 210 determines the presence or absence of a failure of the communication line 9a between the transmission device 1a of the node A and the transmission device 1b of the node B and notifies the determination result to the failure detection unit 200. The failure detection unit 200 is an example of a detection unit. The failure detection unit 200 detects a failure based on the notification from the failure notification unit 210. When the failure detection unit 200 detects a failure, the failure detection unit 200 notifies the detection of the failure to the AIS generation unit 201.

The AIS generation unit 201 is an example of a transmission unit. When the AIS generation unit 201 receives the notification of the failure from the failure detection unit 200, based on the path management table TBL, the AIS generation unit 201 identifies one of the path groups #1 to #5 to which the paths accommodated in the communication line where the failure is detected belong. After that, the AIS generation unit 201 generates AISs for the representative paths of the identified one of the path groups #1 to #5 and outputs the AISs to the AIS insertion unit 240. The AIS insertion unit 240 inserts the AISs input from the AIS generation unit 201 into the main signal S and transmits the resultant main signal S to the transmission device 1c of the adjacent node C.

When for example, a failure of the communication line 9a is detected, based on the path management table TBL, the AIS generation unit 201 identifies the path group #1 of the paths #1 to #1000 accommodated in the communication line 9a. When the failure of the communication line 9a involves switching of all of the paths #1 to #1000 in the path group #1, which are accommodated in the communication line 9a, the AIS generation unit 201 searches for each of the representative path IDs #1, #90, #300, and #900 of the path group #1 in the path management table TBL. The AIS generation unit 201 generates AISs for the representative paths #1, #90, #300, and #900, and transmits the AISs through the AIS insertion unit 240.

In this manner, when the failure detection unit 200 detects a failure, the AIS generation unit 201 transmits AISs for the paths #1, #90, #300, and #900 included in a certain combination of the representative paths included in the paths of the path group #1 to the transmission device 1f of the node F. Accordingly, when the transmission device 1f receives the AISs for the representative paths #1, #90, #300, and #900, the transmission device 1f may determine a request for collective switching of all of the paths in the path group #1.

After certain time elapses after the AIS generation unit 201 has transmitted the AISs for the representative paths #1, #90, #300, and #900, the MS generation unit 201 transmits AISs for the other paths #2 to #89, #91 to #299, and #301 to #899 of the path group #1, which has been identified based on the path management table TBL, to the transmission device 1f of the node F. Accordingly, none of the transmission devices 1c to 1f may fail to notify the NW management device 8 of a failure of the paths #2 to #89, #91 to #299, and #301 to #899.

As described above, the AIS generation unit 201 transmits the AISs for the representative paths #1, #90, #300, and #900 and the AISs for the other paths #2 to #89, #91 to #299, and #301 to #899 in stages. Accordingly, compared to the case like the comparative example of FIG. 2 where the AISs for all of the paths #1 to #1000 are transmitted at a time, the traffic intensity in a network may be flattened in terms of time. As a result, the load of the processes of the CPU in each of the transmission devices 1a to 1h may be reduced.

On receiving an AIS, the interrupt notification unit 310 notifies the occurrence of an interrupt to the AIS processing unit 300. The notification includes the AIS.

The AIS processing unit 300 is an example of a reception unit. The AIS processing unit 300 receives the MS for each path together with the notification of the interrupt occurrence. The AIS processing unit 300 outputs the received AISs to the path switching unit 301. The path switching unit 301 is an example of a switching unit. Based on the path management table TBL, the path switching unit 301 compares the combination of the paths through which the failure notification is received with the combination of the representative paths for each of the path groups #1 to #5. After that, in accordance with the comparison result, the path switching unit 301 switches the paths from the active system to the standby system in units of the path groups #1 to #5.

For example, when the path switching unit 301 receives the AISs for the paths IDs #1, #90, #300, and #900, based on the path management table TBL, the path switching unit 301 identifies each path as belonging to the path group #1. The path switching unit 301 compares the path IDs #1, #90, #300, and #900 of the AISs with representative path IDs #1, #90, #300, and #900 of the identified path group #1.

When the combination of the paths #1, #90, #300, and #900 through which the AISs are received agrees with the combination of the representative path IDs in the path management table TBL, the path switching unit 301 switches each of the paths #1 to #1000 in the path group #1 to the standby system. In this case, as indicated by the arrow x in FIG. 6, the path switching unit 301 performs control so that the main signal S input from the IF unit 32 on the standby path is output to the IF unit 33 by sequentially switching the SEL 340 on the object path to be switched.

As described above, among a plurality of paths, the path switching unit 301 compares the combination of the paths #1, #90, #300, and #900 through which the AIS processing unit 300 has received the AISs with the combination of the paths #1, #90, #300, and #900 in the path management table TBL regarding each of the path groups #1 to #5. The path switching unit 301 switches each of the paths #1 to #1000 in the path group #1 from the active system to the standby system.

Accordingly, the path switching unit 301 may switch all of the paths #2 to #89, #91 to #299, and #301 to #899 other than the representative paths of the path group #1 without performing processes of the reception of AISs, the detection of the AISs, the notification to the CPU of the control unit 30 about an interrupt occurrence, or the detection of the path IDs of the AISs. As a result, the time taken for the path switching may be shortened. The total of the time taken for each process described above accounts for approximately 50 to 70% of the entire processing time taken from the reception of an AIS to the switching of the SEL 340. Thus, the time taken for the path switching may be shortened by approximately 50 to 70%.

As described above, when the combination of the paths through which the AISs are received agrees with the combination of the representative paths of the path group #1, the path switching unit 301 switches each path of the path group #1 concerned from the active system to the standby system. In contrast, when the combination of the paths through which the AISs are received does not agree with the combination of the representative paths in the path management table TBL, the path switching unit 301 switches the paths through which the AISs are received from the active system to the standby system.

That is, when the combination of the path IDs of the AISs does not agree with the combination of the representative path IDs in the path management table TBL, the path switching unit 301 only switches the paths through which the AISs are received from the active system to the standby system. Accordingly, when a failure of an individual path occurs, the path switching unit 301 may switch the path only to the standby path.

The path switching unit 301 determines whether or not, after switching each path in a path group included in the path groups #1 to #5 from the active system to the standby system, the AIS processing unit 300 has received the AISs for all of the paths in the path group included in the path groups #1 to #5 within certain time. Based on the determination result, the path switching unit 301 switches a path in the path group included in the path groups #1 to #5, which includes one or more paths through which the AIS processing unit 300 has received no AIS, from the standby system to the active system.

That is, when an unreceived AIS is present after switching each path in a path group included in the path groups #1 to #5 to the standby system, the path switching unit 301 restores the path corresponding to the unreceived AIS back to the active path. More specifically, when by referring to the path management table TBL, the fallback setting indicates “0”, the path switching unit 301 performs no fallback on the path, or when the fallback setting indicates “1”, the path switching unit 301 performs fallback on the path. The path switching unit 301 performs control so that the main signal S input from the IF unit 31 on the active path is output to the IF unit 33 by switching the SEL 340 of the fallback target path.

Accordingly, even when the path switching unit 301 receives the AISs for the representative paths regardless of it not being the case for switching all of the paths, the path switching unit 301 may return the path that is no switched object, that is, the path through which no AIS is received, to the original active path.

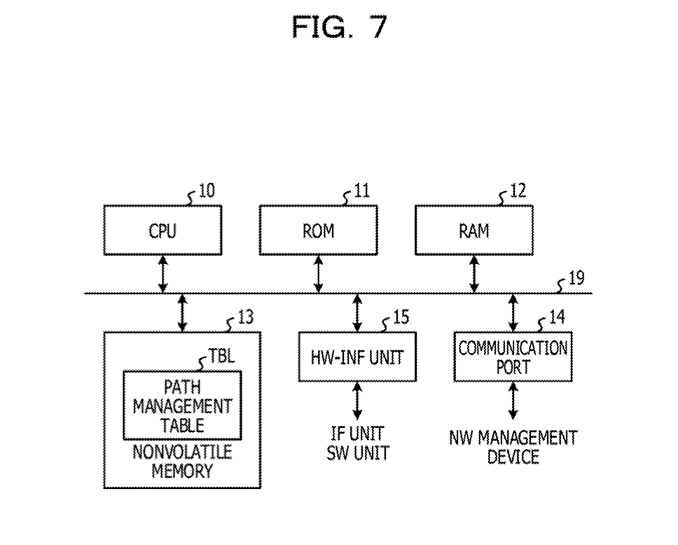

FIG. 7 is a configuration diagram that illustrates an example of the control units 20 and 30. The control units 20 and 30 each include a CPU 10, ROM 11, RAM 12, nonvolatile memory 13, which is an example of a storage unit, a hardware interface (HW-INF) unit 15, and a communication port 14. The CPU 10 is coupled to the ROM 11, the RAM 12, the nonvolatile memory 13, the HW-INF unit 15, and the communication port 14 through a bus 19 so as to be able to input and output signals mutually.

The ROM 11 stores a path switching program for driving the CPU 10. The path switching program executes the above-described path switching method. The RAM 12 functions as working memory of the CPU 10. The communication port 14 is for example, a physical layer/media access control (PHY/MAC) device. Packets are transmitted and received between the communication port 14 and the NW management device 8.

The CPU 10 is an example of a computer that executes the path switching program. When the CPU 10 reads the path switching program from the ROM 11, a plurality of functions are formed. Regarding the transmission device 1b of the node B, the failure detection unit 200 and the AIS generation unit 201 that are described above are formed. As for the transmission device 1f of the node F, the AIS processing unit 300 and the path switching unit 301 that are described above are formed.

The nonvolatile memory 13 stores the path management table TBL. The CPU 10 receives the path management table TBL from the NW management device 8 through the communication port 14 and causes the path management table TBL to be written into the nonvolatile memory 13. The nonvolatile memory 13 of the transmission device 1b of the node B is an example of a first storage unit. The nonvolatile memory 13 of the transmission device 1f of the node F is an example of a second storage unit.

Operations of a process by the CPU 10 are described next.

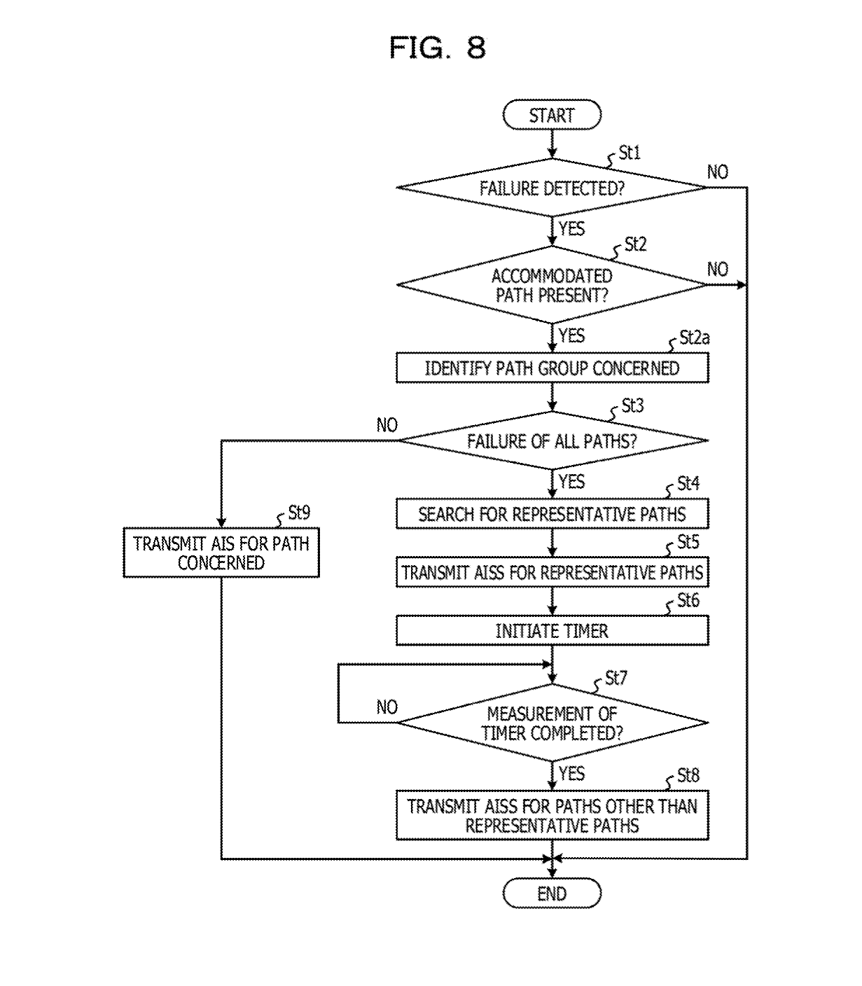

FIG. 8 is a flow chart that illustrates an example of the transmission process of an AIS. The present process is executed in the control unit 20 of the transmission device 1b of the node B.

Based on notification from the failure notification unit 210, the failure detection unit 200 determines whether or not a failure is detected (St1). When no failure is detected (No in St1), the failure detection unit 200 ends the process.

When the failure detection unit 200 detects a failure (Yes in St1), the AIS generation unit 201 determines the presence or absence of a path accommodated in the communication line with the failure, which is included in the communication lines 9a to 9h (St2). When no path is present (No in St2), the AIS generation unit 201 ends the process.

When a path is present (Yes in St2), based on the path management table TBL, the AIS generation unit 201 identifies a path group corresponding to the path (St2a). The identified path group may be one or more path groups.

After that, the AIS generation unit 201 determines whether or not the detected failure is a failure of all of the paths in the identified path group (St3). For example, when the failure in the communication lines 9a to 9h is cutting of an optical fiber, all of the paths accommodated in the communication line with the failure, which is included in the communication lines 9a to 9h, are put out of communication. Accordingly, the AIS generation unit 201 determines the failure as the failure of all of the paths.

When the detected failure is not the failure of all of the paths (No in St3), the AIS generation unit 201 transmits an AIS only for the path of the failure (St9). When the detected failure is the failure of all of the paths (Yes in St3), the AIS generation unit 201 searches for the representative paths of the path group concerned in the path management table TBL (St4). After that, the AIS generation unit 201 transmits AISs for the representative paths (St5).

As described above, when the failure detection unit 200 detects a failure, based on the path management table TBL, the AIS generation unit 201 identifies a path group to which the paths accommodated in the communication line of the communication lines 9a to 9h, where the failure has been detected, belong. After that, the AIS generation unit 201 transmits an AIS for each of the paths that belong to the combination of the representative paths in the identified path group.

After that, the AIS generation unit 201 initiates a timer that measures certain time (St6). After that, the AIS generation unit 201 determines whether or not the timer has completed the measurement (St7). When the timer has not completed the measurement (No in St7), the AIS generation unit 201 determines again whether or not the timer has completed the measurement (St7).

When the timer has completed the measurement (Yes in St7), the AIS generation unit 201 transmits AISs for the paths other than the representative paths in the path group concerned (St8). In this manner, the transmission process of an AIS is executed.

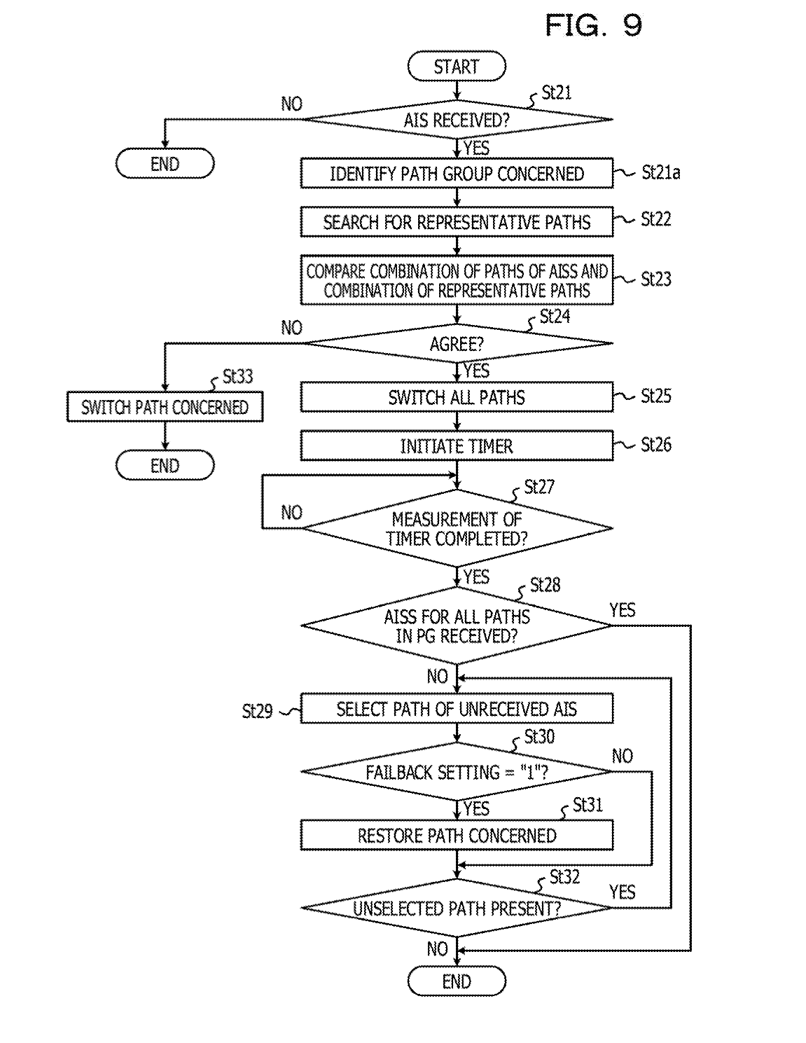

FIG. 9 is a flow chart that illustrates an example of the path switching process. This process is executed in the control unit 30 of the transmission device 1f of the node F.

The AIS processing unit 300 determines the presence or absence of the reception of an AIS from the interrupt notification unit 310 (St21). When no AIS is received (No in St21), the AIS processing unit 300 ends the process. When the AIS processing unit 300 has received an AIS (Yes in St21), based on the path management table TBL, the path switching unit 301 identifies the path group to which the paths through which the AISs are received belong (St21a).

After that, the path switching unit 301 searches for the representative paths of the path group concerned in the path management table TBL (St22). After that, the path switching unit 301 compares the combination of the paths through which the AISs are received with the combination of the representative paths that have undergone the search regarding each path group (St23). When the combination of the paths through which the AISs are received does not agree with the combination of the representative paths that have undergone the search (No in St24), the path switching unit 301 only switches the paths through which the AIS are received from the active system to the standby system (St33).

When the combination of the paths through which the AISs are received agrees with the combination of the representative paths that have undergone the search (Yes in St24), the path switching unit 301 switches each path in the path group concerned from the active system to the standby system (St25).

After that, the path switching unit 301 initiates a timer that measures certain tithe (St26). After that, the path switching unit 301 determines whether or not the timer has completed the measurement (St27). When the timer has not completed the measurement (No in St27), the path switching unit 301 determines again whether or not the timer has completed the measurement (St27).

When the timer has completed the measurement (Yes in St27), the path switching unit 301 determines whether or not AISs for all of the paths that belong to a path group (PG) concerned have been received in the AIS processing unit 300 (St28). When AISs for all of the paths have been received (Yes in St28) according to the determination result, the path switching unit 301 ends the process.

When one or more paths for which, among the paths in the path group concerned, no AIS is received are present (No in St28), the path switching unit 301 selects one of the paths through which no AISs are received (St29). After that, the path switching unit 301 determines whether or not the fallback setting for the selected path indicates “1” (St30).

When the failback setting for the selected path indicates “1” (Yes in St30), the path switching unit 301 restores the path back to the active system (St31). When the failback setting for the selected path indicates “0” (No in St30), the path switching unit 301 performs no fallback.

After that, the path switching unit 301 determines whether or not an unselected path is present among the paths through which no AISs are received (St32). When an unselected path is present (Yes in St32), the path switching unit 301 selects another path (St29) and executes the operation of St30 again. When no unselected path is present (No in St32), the path switching unit 301 ends the process. In this manner, the path switching process is executed.

The above-described processing functions may be implemented by a computer. In this case, a program where the processing contents of the functions that a processor is desired to have are described is provided. The above-described processing functions are implemented on the computer by the program being executed by the computer. The program where the processing contents are described may be recorded in a computer-readable recording medium excluding a carrier wave.

When the program is distributed, for example, the program is sold in the form of a portable recording medium where the program is recorded, such as a digital versatile disc (DVD) or compact disc read only memory (CD-ROM). The program may be stored in a storage device of a server computer and be transferred from the server computer to another computer through a network.

For example, the computer that executes the program causes the program recorded in a portable recording medium or the program transferred from a server computer to be stored in a storage device of the computer. Then, the computer reads the program from its own storage device and executes a process in accordance with the program. The computer may read the program directly from a portable recording medium and execute a process in accordance with the program. Every time a program is transferred from a server computer, the computer may execute a process in accordance with the program one by one.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A switching method executed by a processor included in a transmission device that communicates with another transmission device using a plurality of paths, the switching method comprising:
receiving a failure notification from the another transmission device through each of two or more paths included in the plurality of paths;
by referring to path management information in which a group and a combination of a plurality of predetermined paths are associated with each other for each of a plurality of groups generated by grouping the plurality of paths according to a combination of an initial point and an end point, determining, for each of the plurality of groups, whether a combination of paths through which the failure notification is received matches with the combination of the plurality of predetermined paths; and
switching a path included in an object group corresponding to the two or more paths among the plurality of groups from an active system to a standby system, when it is determined that the combination of the two or more paths matches with the combination of the plurality of predetermined paths.

2. The switching method according to claim 1, further comprising
switching the two or more paths from the active system to the standby system when it is determined that the combination of the two or more paths does not match with the combination of the plurality of predetermined paths for all of the plurality of groups.

3. The switching method according to claim 1, further comprising:
determining whether the failure notification is received within certain time for each of paths included in the object group after the switching; and
when it is determined that the failure notification is not received through a path included in the object group, switching the path from the standby system to the active system.

4. The switching method according to claim 1, wherein
the transmission device and the another transmission device are included in a plurality of transmission devices that form a ring network, and
the switching includes switching a transmission direction of a signal using a path included in the object group so that the transmission direction is reversed on the ring network.

5. The switching method according to claim 1, wherein
the receiving includes receiving the failure notification through each of paths that belong to a second group included in the plurality of groups after a predetermined time elapses after receiving the failure notification through each of paths that belong to a first group included in the plurality of groups,

6. A transmission device that communicates with another transmission device using a plurality of paths, the transmission device comprising:
a memory; and
a processor coupled to the memory and configured to:
receive a failure notification from the another transmission device through each of two or more paths included in the plurality of paths,
by referring to path management information in which a group and a combination of a plurality of predetermined paths are associated with each other for each of a plurality of groups generated by grouping the plurality of paths according to a combination of an initial point and an end point, determine, for each of the plurality of groups, whether a combination of paths through which the failure notification is received matches with the combination of the plurality of predetermined paths, and
switch a path included in an object group corresponding to the two or more paths among the plurality of groups from an active system to a standby system, when it is determined that the combination of the two or more paths matches with the combination of the plurality of predetermined paths.

7. The transmission device according to claim 6, wherein the processor is further configured to
switch the two or more paths from the active system to the standby system when it is determined that the combination of the two or more paths does not match with the combination of the plurality of predetermined paths for all of the plurality of groups.

8. The transmission device according to claim 6, wherein the processor is further configured to:
determine whether the failure notification is received within certain time for each of paths included in the object group after the switching; and
when it is determined that the failure notification is not received through a path included in the object group, switch the path from the standby system to the active system.

9. The transmission device according to claim 6, wherein
the transmission device and the another transmission device are included in a plurality of transmission devices that form a ring network, and
the processor is further configured to
switch a transmission direction of a signal using a path included in the object group so that the transmission direction is reversed on the ring network.

10. The transmission device according to claim 6, wherein the processor is further configured to
receive the failure notification through each of paths that belong to a second group included in the plurality of groups after a predetermined time elapses after receiving the failure notification through each of paths that belong to a first group included in the plurality of groups.

11. A non-transitory computer-readable recording medium storing a program that causes a processor included in a transmission device that communicates with another transmission device using a plurality of paths to execute a process, the process comprising:
receiving a failure notification from the another transmission device through each of two or more paths included in the plurality of paths;
by referring to path management information in which a group and a combination of a plurality of predetermined paths are associated with each other for each of a plurality of groups generated by grouping the plurality of paths according to a combination of an initial point and an end point, determining, for each of the plurality of groups, whether a combination of paths through which the failure notification is received matches with the combination of the plurality of predetermined paths; and
switching a path included in an object group corresponding to the two or more paths among the plurality of groups from an active system to a standby system, when it is determined that the combination of the two or more paths matches with the combination of the plurality of predetermined paths.

12. The recording medium according to claim 11, wherein the process further comprising
switching the two or more paths from the active system to the standby system when it is determined that the combination of the two or more paths does not match with the combination of the plurality of predetermined paths for all of the plurality of groups.

13. The recording medium according to claim 11, wherein the process further comprising:
determining whether the failure notification is received within certain time for each of paths included in the object group after the switching; and
when it is determined that the failure notification is not received through a path included in the object group, switching the path from the standby system to the active system.

14. The recording medium according to claim 11, wherein
the transmission device and the another transmission device are included in a plurality of transmission devices that form a ring network, and
the switching includes switching a transmission direction of a signal using a path included in the object group so that the transmission direction is reversed on the ring network.
